(19) United States
(12) Patent Application Publication
(10) Pub. No.: US 2011/0041513 A1
(43) Pub. Date: Feb. 24, 2011

(54) POLYCRYSTALLINE MAGNETOCALORIC MATERIALS

(75) Inventor: Bennie REESINK, Winterswijk-Kotten (NL)

Correspondence Address: OBLON, SPIVAK, MCCLELLAND MAIER & NEUSTADT, L.L.P., 1940 DUKE STREET, ALEXANDRIA, VA, 22314, US

(73) Assignee: Technology Foundation STW, Utrecht (NL)

(21) Appl. No.: 12/852,750

(22) Filed: Aug. 9, 2010

(30) Foreign Application Priority Data
Aug. 18, 2009 (EP) 09168051.2

(51) Int. Cl. F25B 21/00; C09K 5/00

(52) U.S. Cl. 62/3.1; 252/67

(57) ABSTRACT

What are described are polycrystalline magnetocaloric materials of the general formula

MnₐCo_{b}Ge_{c}Aₓ

with A, B or C
0≦x≦0.5,
0.9≦a≦1.1,
0.9≦b≦1.1,
0.9≦c≦1.0,
where up to 30 mol % of the Mn or Co may be replaced by Fe, Ni, Cr, V or Cu or up to 30 mol % of the Mn, Co or Ge may be replaced by vacancies,
in which phases of the orthorhombic TiNiSi structure type and of the hexagonal Ni₂In structure type are present at a temperature below −40° C.

The invention relates to polycrystalline magnetocaloric materials, to processes for their production and to their use in coolers, heat exchangers or generators, in particular refrigerators.

Thermomagnetic materials, also referred to as magnetocaloric materials, can be used for cooling, for example in refrigerators or air conditioning units, in heat pumps or for direct generation of power from heat without intermediate connection of a conversion to mechanical energy.

Such materials are known in principle and are described, for example, in WO 2004/068512. Magnetic cooling techniques are based on the magnetocaloric effect (MCE) and may constitute an alternative to the known vapor circulation cooling methods. In a material which exhibits a magnetocaloric effect, the alignment of randomly aligned magnetic moments by an external magnetic field leads to heating of the material. This heat can be removed from the MCE material to the surrounding atmosphere by a heat transfer. When the magnetic field is then switched off or removed, the magnetic moments revert back to a random arrangement, which leads to cooling of the material below ambient temperature. This effect can be exploited for cooling purposes; see also Nature, Vol. 415, Jan. 10, 2002, pages 150 to 152. Typically, a heat transfer medium such as water is used for heat removal from the magnetocaloric material.

The materials used in thermomagnetic generators are likewise based on the magnetocaloric effect. In a material which exhibits a magnetocaloric effect, the alignment of randomly aligned magnetic moments by an external magnetic field leads to heating of the material. This heat can be released by the MCE material into the surrounding atmosphere by a heat transfer. When the magnetic field is then switched off or removed, the magnetic moments revert back to a random alignment, which leads to cooling of the material below ambient temperature. This effect can be exploited firstly for cooling purposes, and secondly for conversion of heat to electrical energy.

The magnetocaloric generation of electrical energy is associated with magnetic heating and cooling. At the time of first conception, the process for energy generation was described as pyromagnetic energy generation. Compared to devices of the Peltier or Seebeck type, these magnetocaloric devices can have a significantly higher energy efficiency.

The research into this physical phenomenon began in the late 19^{th} century, when two scientists, Tesla and Edison, filed a patent on pyromagnetic generators. In 1984, Kirol described numerous possible applications and conducted thermodynamic analyses thereof. At that time, gadolinium was considered to be a potential material for applications close to room temperature.

A pyromagnetoelectric generator is described, for example, by N. Tesla in U.S. Pat. No. 428,057. It is stated that the magnetic properties of iron or other magnetic substances can be destroyed partially or entirely or can disappear as a result of heating to a particular temperature. In the course of cooling, the magnetic properties are re-established and return to the starting state. This effect can be exploited to generate electrical power. When an electrical conductor is exposed to a varying magnetic field, the changes in the magnetic field lead to the induction of an electrical current in the conductor. When, for example, the magnetic material is surrounded by a coil and is then heated in a permanent magnetic field and then cooled, an electrical current is induced in the coil in the course of heating and cooling in each case. This allows thermal energy to be converted to electrical energy, without an intermediate conversion to mechanical work. In the process described by Tesla, iron, as the magnetic substance, is heated by means of an oven or a closed fireplace and then cooled again.

For the thermomagnetic or magnetocaloric applications, the material should permit efficient heat exchange in order to be able to achieve high efficiencies. Both in the course of cooling and in the course of power generation, the thermomagnetic material is used in a heat exchanger.

It is an object of the present invention to provide magnetocaloric materials having a large magnetocaloric effect.

The object is achieved in accordance with the invention by polycrystalline magnetocaloric materials of the general formula

MnₐCo_{b}Ge_{c}Aₓ

where
A is B or C; i.e. boron or carbon
0≦x≦0.5,
0.9≦a≦1.1,
0.9≦b≦1.1,
0.9≦c≦1.0,
where up to 30 mol % of the Mn or Co may be replaced by Fe, Ni, Cr, V or Cu or up to 30 mol % of the Mn, Co or Ge may be replaced by vacancies,
in which phases of the orthorhombic TiNiSi structure type and of the hexagonal Ni₂In structure type are present at a temperature below −40° C.

In one embodiment of the invention, 2.8<a+b+c<3.2 or a+b+c=3. A may be boron or carbon.

It has been found in accordance with the invention that polycrystalline magnetocaloric materials in which both phases of the orthorhombic TiNiSi structure type and those of the hexagonal Ni₂In structure type are present exhibit an unexpectedly high magnetocaloric effect. The materials are effectively intrinsically biphasic magnetocaloric materials. Preferably at least 5% by weight, more preferably at least 10% by weight, especially at least 15% by weight, of the two phases mentioned are present in the polycrystalline magnetocaloric materials.

Compared to the inventive materials, those materials which comprise only one of the phases specified exhibit only small magnetocaloric effects. This is all the more astonishing in that it is normally assumed that monophasic materials have more favorable use properties.

Two types of magnetocaloric materials exhibit this effect: materials of the MnCoGe type which are nonstoichiometric and either exhibit vacancies in the Ge sublattice or Fe, Ni, Cr, V or Cu substitutions in the Co sublattice.

In addition, MnCoGe structures formed by boron as interstitial atoms, which are obtained by adding small amounts of boron to stoichiometric MnCoGe, exhibit large magnetocaloric effects. The greatest magnetocaloric effects are observed for interstitial alloys.

The adjustment of the ratios can adjust the phase transitions, as a result of which the magnetic moments and the magnetocaloric effect in turn can be adjusted. Above the Curie temperature, the materials are generally present in monophasic form, but in biphasic form below the Curie temperature.

The intermetallic compound MnCoGe crystallizes in the orthorhombic TiNiSi structure type at a Curie temperature of 345 K. MnCoGe exhibits a typical second-order magnetic phase transition. With a magnetic field change of 5 T, the isothermal magnetic entropy change of MnCoGe is about 5 J kg⁻¹K⁻¹. It would have been expected that the replacement of Co by other elements would lower both the magnetic moment and the Curie temperature. It has been found, however, in accordance with the invention that the possible structural transition from the orthorhombic TiNiSi structure type to the hexagonal Ni₂In structure type leads to large magnetocaloric effects in the compounds.

In the inventive magnetocaloric materials, preferably, 0.001<x<0.1. More preferably, x has the value of 0.01 to 0.05.

Preferably, up to 25 mol % of the Mn or Co is replaced as specified, more preferably 1 to 20 mol %, especially 3 to 10 mol %.

The thermomagnetic materials used in accordance with the invention can be produced in any suitable manner.

The inventive magnetocaloric materials can be produced by solid phase conversion or liquid phase conversion of the starting elements or starting alloys for the material, subsequently cooling, then pressing, sintering and heat treating under inert gas atmosphere and subsequently cooling to room temperature, or by melt spinning of a melt of the starting elements or starting alloys.

The thermomagnetic materials are produced, for example, by solid phase reaction of the starting elements or starting alloys for the material in a ball mill, subsequent pressing, sintering and heat treatment under inert gas atmosphere and subsequent cooling; for example slow cooling, to room temperature. Such a process is described, for example, in J. Appl. Phys. 99, 2006, 08Q107.

Processing via melt spinning is also possible. This makes possible a more homogeneous element distribution which leads to an improved magnetocaloric effect; cf. Rare Metals, Vol. 25, October 2006, pages 544 to 549. In the process described there, the starting elements are first induction-melted in an argon gas atmosphere and then sprayed in the molten state through a nozzle onto a rotating copper roller. There follows sintering at 1000° C. and slow cooling to room temperature.

In addition, reference may be made to WO 2004/068512 for the production.

Preference is therefore given to a process for producing the thermomagnetic materials, comprising the following steps:
a) converting chemical elements and/or alloys in a stoichiometry which corresponds to the metal-based material in the solid and/or liquid phase,
b) optionally converting the reaction product from stage a) to a solid,
c) sintering and/or heat treating the solid from stage a) or b),
d) quenching the sintered and/or heat treated solid from stage c) at a cooling rate of at least 100 K/s.

The thermal hysteresis can be reduced significantly and a large magnetocaloric effect can be achieved when the metal-based materials are not cooled slowing to ambient temperature after the sintering and/or heat treatment, but rather are quenched at a high cooling rate. This cooling rate is at least 100 K/s. The cooling rate is preferably from 100 to 10 000 K/s, more preferably from 200 to 1300 K/s. Especially preferred cooling rates are from 300 to 1000 K/s.

The quenching can be achieved by any suitable cooling processes, for example by quenching the solid with water or aqueous liquids, for example cooled water or ice/water mixtures. The solids can, for example, be allowed to fall into ice-cooled water. It is also possible to quench the solids with subcooled gases such as liquid nitrogen. Further processes for quenching are known to those skilled in the art. What is advantageous here is controlled and rapid cooling.

The rest of the production of the thermomagnetic materials is less critical, provided that the last step comprises the quenching of the sintered and/or heat treated solid at the inventive cooling rate. The process may be applied to the production of any suitable thermomagnetic materials for magnetic cooling, as described above.

In step (a) of the process, the elements and/or alloys which are present in the later thermomagnetic material are converted in a stoichiometry which corresponds to the thermomagnetic material in the solid or liquid phase.

Preference is given to performing the reaction in stage a) by combined heating of the elements and/or alloys in a closed vessel or in an extruder, or by solid phase reaction in a ball mill. Particular preference is given to performing a solid phase reaction, which is effected especially in a ball mill. Such a reaction is known in principle; cf. the documents cited above. Typically, powders of the individual elements or powders of alloys of two or more of the individual elements which are present in the later thermomagnetic material are mixed in pulverulent form in suitable proportions by weight. If necessary, the mixture can additionally be ground in order to obtain a microcrystalline powder mixture. This powder mixture is preferably heated in a ball mill, which leads to further comminution and also good mixing, and to a solid phase reaction in the powder mixture. Alternatively, the individual elements are mixed as a powder in the selected stoichiometry and then melted.

The combined heating in a closed vessel allows the fixing of volatile elements and control of the stoichiometry. Specifically in the case of use of phosphorus, this would evaporate easily in an open system.

The reaction is followed by sintering and/or heat treatment of the solid, for which one or more intermediate steps can be provided. For example, the solid obtained in stage a) can be subjected to shaping before it is sintered and/or heat treated.

Alternatively, it is possible to send the solid obtained from the ball mill to a melt-spinning process. Melt-spinning processes are known per se and are described, for example, in Rare Metals, Vol. 25, October 2006, pages 544 to 549, and also in WO 2004/068512.

In these processes, the composition obtained in stage a) is melted and sprayed onto a rotating cold metal roller. This spraying can be achieved by means of elevated pressure upstream of the spray nozzle or reduced pressure downstream of the spray nozzle. Typically, a rotating copper drum or roller is used, which can additionally be cooled if appropriate. The copper drum preferably rotates at a surface speed of from 10 to 40 m/s, especially from 20 to 30 m/s. On the copper drum, the liquid composition is cooled at a rate of preferably from 10² to 10⁷ K/s, more preferably at a rate of at least 10⁴ K/s, especially with a rate of from 0.5 to 2×10⁶ K/s.

The melt-spinning, like the reaction in stage a) too, can be performed under reduced pressure or under an inert gas atmosphere.

The melt-spinning achieves a high processing rate, since the subsequent sintering and heat treatment can be shortened. Specifically on the industrial scale, the production of the thermomagnetic materials thus becomes significantly more economically viable. Spray-drying also leads to a high processing rate. Particular preference is given to performing melt spinning.

Alternatively, in stage b), spray cooling can be carried out, in which a melt of the composition from stage a) is sprayed into a spray tower. The spray tower may, for example, additionally be cooled. In spray towers, cooling rates in the range from 10³ to 10⁵ K/s, especially about 10⁴ K/s, are frequently achieved.

The sintering and/or heat treatment of the solid is effected in stage c) preferably first at a temperature in the range from 800 to 1400° C. for sintering and then at a temperature in the range from 500 to 750° C. for heat treatment. For example, the sintering can then be effected at a temperature in the range from 500 to 800° C. For shaped bodies/solids, the sintering is more preferably effected at a temperature in the range from 1000 to 1300° C., especially from 1100 to 1300° C. The heat treatment can then be effected, for example, at from 600 to 700° C.

The sintering is performed preferably for a period of from 1 to 50 hours, more preferably from 2 to 20 hours, especially from 5 to 15 hours. The heat treatment is performed preferably for a period in the range from 10 to 100 hours, more preferably from 10 to 60 hours, especially from 30 to 50 hours. The exact periods can be adjusted to the practical requirements according to the materials.

In the case of use of the melt-spinning process, the period for sintering or heat treatment can be shortened significantly, for example to periods of from 5 minutes to 5 hours, preferably from 10 minutes to 1 hour. Compared to the otherwise customary values of 10 hours for sintering and 50 hours for heat treatment, this results in a major time advantage.

The sintering/heat treatment results in partial melting of the particle boundaries, such that the material is compacted further.

The melting and rapid cooling in stage b) thus allows the duration of stage c) to be reduced considerably. This also allows continuous production of the thermomagnetic materials.

The inventive magnetocaloric materials can be used in any suitable applications. For example, they are used in coolers, heat exchangers or generators. Particular preference is given to use in refrigerators.

The invention is illustrated in detail by examples.

### EXAMPLES

Polycrystalline samples of the MnCoGe type were produced by light arc melting from stoichiometric amounts of the pure elements. In order to obtain a homogeneous phase, the cast samples were heat treated at 500° C. or 800° C. under an argon atmosphere of 500 mbar for 5 days and then quenched in water at room temperature. The crystal structure was determined by X-ray scattering on a powder sample at room temperature. DC magnetization was determined in a quantum design MPMS2 Squid magnetometer operating in fields of up to 5 T and within a temperature range from 5 to 400 K.

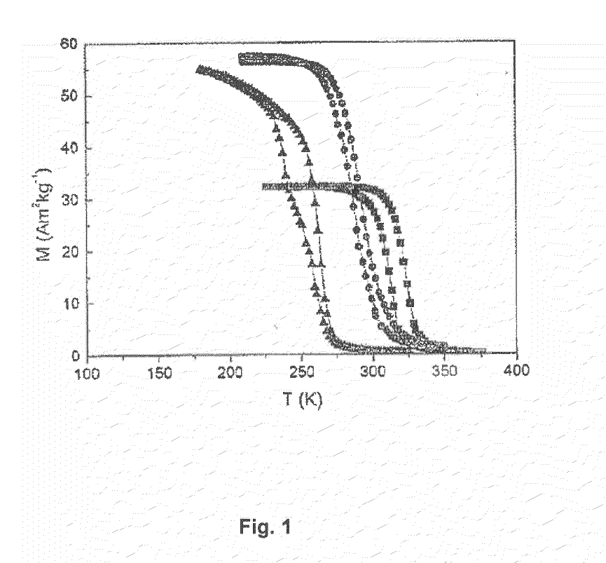

FIG. 1 shows the temperature dependence of the magnetization of MnCoGe_{0.98}, Mn_{0.9}Fe_{0.1}CoGe ad MnCo_{0.9}Cu_{0.1}Ge, determined at a magnetic field of 0.1 T (square, circle and triangle respectively). Only the middle sample was heat treated. The values of the Curie temperature for MnCoGe_{0.98}, Mn_{0.9}Fe_{0.1}CoGe and MnCo_{0.9}Cu_{0.1}Ge are 325 K, 292 K and 263 K. A thermal hysteresis is observed at the transition from the ferromagnetic to the paramagnetic state, corresponding to a first-order magnetic transition.

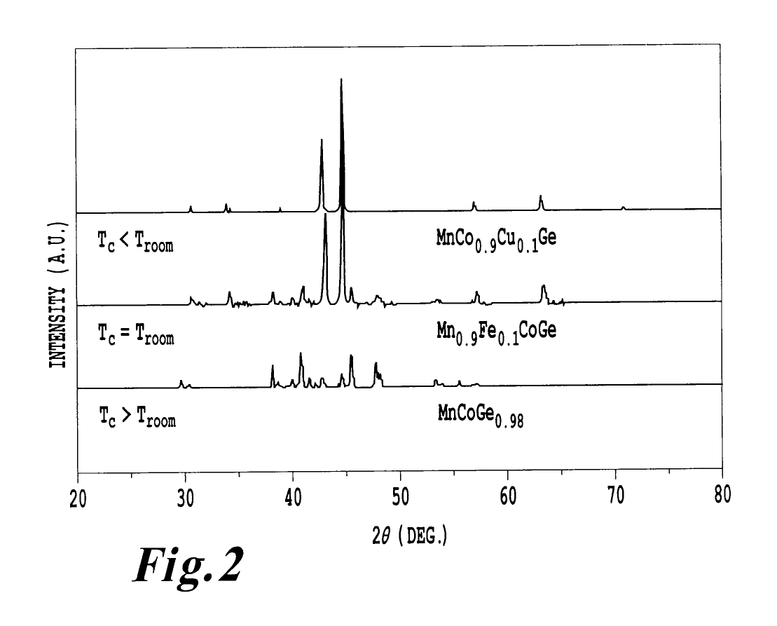

FIG. 2 shows X-ray structure patterns of MnCoGe_{0.98}, Mn_{0.9}Fe_{0.1}CoGe and MnCo_{0.9}Cu_{0.1}Ge, determined at room temperature. For the sample whose critical temperature is significantly below room temperature, only the magnitude of a single phase of the Ni₂In type is observed, since the measurement temperature is above the critical temperature. The intensity is plotted in arbitrary units.

Magnetic properties of nonstoichiometric MnCoGe compounds are summarized in table 1 below. A significant increase in the magnetocaloric effect is observed with only slightly altered magnetic moments.

TABLE 1

| | | ΔT_{hys} | −ΔSₘ (JKg⁻¹K⁻¹) | M_{S} (μ_{B}/f.u.) |
|---|---|---|---|---|
| | T_{c} (K) | (K) | ΔB = 0-5 T | T = 5 K |
| MnCoGe | 345 | 0 | 5.0 | 4.0 |
| MnCo_{0.9}Cu_{0.1}Ge | 264 | — | 9.6 | 3.5 |
| MnCo_{0.9}Ni_{0.1}Ge | 302 | — | 9.2 | 3.8 |
| MnCo_{0.95}Fe_{0.05}Ge | 282 | — | 11.3 | 4.0 |
| Mn_{0.97}Cr_{0.03}CoGe | 304 | — | 11.0 | 3.8 |
| Mn_{0.95}V_{0.05}CoGe | 318 | — | 12.6 | 3.6 |
| Mn_{0.90}Fe_{0.10}CoGe | 291 | — | 12.6 | 3.7 |
| MnCo_{0.97}Ge | 289 | — | 11.0 | 3.9 |
| MnCoGe_{0.98} | 324 | — | 16.0 | 3.8 |
| MnCo_{0.98}Cu_{0.02}Ge | 322 | 1 | 6.5 | 4.10 |
| MnCo_{0.96}Cu_{0.04}Ge | 315 | 4 | 10.6 | 3.93 |
| Mn_{0.96}Cr_{0.04}CoGe | 317 | 10 | 28.5 | 3.65 |
| Mn_{0.93}Cr_{0.07}CoGe | 296 | 11 | 22.8 | 3.46 |
| Mn_{0.91}Cr_{0.09}CoGe | 278 | 10 | 20.7 | 3.38 |
| MnCo_{0.92}Ni_{0.08}CoGe | 321 | 11 | 21.8 | 3.76 |
| MnCo_{0.86}Ni_{0.14}CoGe | 327 | 10 | 24.7 | 3.72 |
| MnCo_{0.83}Ni_{0.17}CoGe | 308 | 6 | 21.7 | 3.58 |
| MnFe_{0.03}Co_{0.97}Ge | 306 | 7 | 18.8 | 3.00 |
| Mn_{0.98}CoGe | 302 | 11 | 30.2 | 3.96 |
| MnCo_{0.97}Ge | 327 | 5 | 21.3 | 4.06 |

The addition of numerous boron atoms to the MnCoGe alloy leads to a first-order phase transition. X-ray diffractograms for MnCoGeBₓ compounds where x=0.01, 0.02 and 0.03 show, in the case of heat treatment close to 500° C., the simultaneous existence of the hexagonal and orthorhombic structures.

The magnetization curves for MnCoGeB_{0.02} which had been heat treated at 500° C. show clear thermal hysteresis. The sample additionally shows a virgin effect. The hysteresis is 32 K for the first cooling and first heating, but only 16 K for the subsequent cooling and heating.

Very large magnetocaloric effects are observed for different compositions. The greatest value of 67.3 J kg⁻¹K⁻¹ for a change in the magnetic field of 5 T is observed for a sample with x=0.01, with 3% vacancies in the cobalt content and heat treatment of the sample at 850° C.

Table 2 reports the changes in the ordering temperature (T_{c}), the thermal hysteresis (ΔThys), the change in the magnetic entropy (−ΔSm) and the magnetic moment for MnCoGeBₓ compounds which have been heat treated at 850° C.

TABLE 2

| | | | −ΔSₘ | |
|---|---|---|---|---|
| | | −ΔT_{hys} | (JKg⁻¹K⁻¹) | M_{S} (μ_{B}/f,u,) |
| | T_{c} (K) | (K) | ΔB = 0-5 T | T = 5 K |
| MnCoGe (850° C.) | 345 | 0 | 5.6 | 4.13 |
| MnCoGeB_{0.01} (850° C.) | 344 | 2 | 12 | 3.80 |
| MnCoGeB_{0.02} (500° C.) | 304 | 16 | 20.2 | 3.86 |
| MnCoGeB_{0.02} (850° C.) | 286 | 14 | 47.3 | 3.86 |
| MnCoGeB_{0.03} (850° C.) | 270 | 9 | 37.7 | 3.86 |
| MnCo_{0.98}Cu_{0.02}GeB_{0.02} | 316 | 10 | 43.9 | 4.13 |
| MnCo_{0.98}Cu_{0.02}GeB_{0.03} | 279 | 9 | 62.1 | 4.02 |
| MnCo_{0.96}Cu_{0.04}GeB_{0.02} | 308 | 12 | 48.6 | 3.96 |
| Mn_{0.96}Cr_{0.04}CoGeB_{0.02} | 303 | 11 | 46.9 | 3.89 |
| Mn_{0.96}Cr_{0.04}CoGeB_{0.03} | 287 | 12 | 41.5 | 3.84 |
| Mn_{0.93}Cr_{0.07}CoGeB_{0.02} | 297 | 12 | 50.0 | 3.73 |
| MnCo_{0.92}Ni_{0.08}GeB_{0.03} | 290 | 11 | 34.3 | 3.86 |
| MnCo_{0.92}Ni_{0.08}GeB_{0.02} | 329 | 11 | 44.3 | 4.09 |
| MnCo_{0.85}Ni_{0.14}GeB_{0.02} | 311 | 10 | 45.8 | 3.70 |
| MnCo_{0.83}Ni_{0.17}GeB_{0.02} | 304 | 11 | 46.4 | 3.84 |
| MnFe_{0.03}Co_{0.97}GeB_{0.02} | 327 | 11 | 44.3 | 4.05 |
| Mn_{0.98}CoGeB_{0.01} | 285 | 10 | 64.2 | 4.09 |
| MnCo_{0.97}GeB_{0.01} | 291 | 14 | 67.3 | 4.02 |
| Mn_{0.96}Co_{1.04}GeB_{0.01} | 328 | 5 | 28.7 | 3.64 |

1. A polycrystalline magnetocaloric material of the general formula
MnₐCo_{b}Ge_{c}Aₓ
with A; B or C,
0≦x≦0.5,
0.9≦a≦1.1,
0.9≦b≦1.1,
0.9≦c≦1.0,
where up to 30 mol % of the Mn or Co may be replaced by Fe, Ni, Cr, V or Cu or up to 30 mol % of the Mn, Co or Ge may be replaced by vacancies,
in which phases of the orthorhombic TiNiSi structure type and of the hexagonal Ni₂In structure type are present at a temperature below −40° C.

2. The magnetocaloric material according to claim 1, wherein 0.001<x<0.1.

3. The magnetocaloric material according to claim 2, wherein x has the value of 0.01 to 0.05.

4. The magnetocaloric material according to claim 1, wherein up to 25 mol % of the Mn or Co may be replaced as specified.

5. The magnetocaloric material according to claim 4, wherein 1 to 20 mol %, preferably 3 to 10 mol %, of the Mn or Co is replaced as specified.

6. A process for producing the magnetocaloric materials according to claim 1 by solid phase conversion or liquid phase conversion of the starting elements or starting alloys for the material, optionally cooling, then pressing, sintering and heat treating under inert gas atmosphere and subsequently cooling to room temperature, or by melt spinning of a melt of the starting elements or starting alloys.

7. The process according to claim 6, comprising the following steps:
a) converting chemical elements and/or alloys in a stoichiometry which corresponds to the metal-based material in the solid and/or liquid phase,
b) optionally converting the reaction product from stage a) to a solid,
c) sintering and/or heat treating the solid from stage a) or b),
d) quenching the sintered and/or heat treated solid from stage c) at a cooling rate of at least 100 K/s.

8. Coolers, heat exchangers or generators, containing the magnetocaloric materials according to claim 1.
